(19) United States
(12) Patent Application Publication
(10) Pub. No.: US 2010/0112449 A1
(43) Pub. Date: May 6, 2010

(54) POSITIVE ELECTRODE FOR NON-AQUEOUS ELECTROLYTE SECONDARY BATTERY AND NON-AQUEOUS ELECTROLYTE SECONDARY BATTERY

(76) Inventors: Hideaki Fujita, Osaka (JP); Yukihiro Okada, Osaka (JP)

Correspondence Address: MCDERMOTT WILL & EMERY LLP, 600 13TH STREET, NW, WASHINGTON, DC, 20005-3096, US

(21) Appl. No.: 12/593,795

(22) PCT Filed: Mar. 3, 2008
(86) PCT No.: PCT/JP2008/000425

§ 371 Date: Sep. 29, 2009

(30) Foreign Application Priority Data
Mar. 29, 2007 (JP) 2007-087437

(51) Int. Cl. H01M 4/48; H01M 4/58

(52) U.S. Cl. 429/231; 429/231.95

(57) ABSTRACT

In a positive electrode active material layer, 80% by weight or more of the total amount of a positive electrode active material is in the form of primary particles, and a conductive coating layer is provided on the surfaces of the primary particles. This sufficiently suppresses the collapse of the active material itself associated with repeated charge and discharge and the changes in volume of the active material layer associated with the collapse, without the need of increasing the content of conductive agent in the positive electrode active material layer. This particularly prevents part of the positive electrode active material particles from being isolated from the electrically conductive network in the positive electrode active material. As a result, the conductive network firmly formed among the primary particles is maintained, and therefore, both the output characteristics and the life characteristic can be improved to a high degree, and a higher output power and a longer life of the battery can be achieved.

### TECHNICAL FIELD

The present invention relates to a positive electrode for a non-aqueous electrolyte secondary battery and a non-aqueous electrolyte secondary battery. Specifically, the present invention mainly relates to an improvement of a positive electrode active material in a non-aqueous electrolyte secondary battery.

### BACKGROUND ART

Recently, electronic devices, in particular, small-sized consumer electronic devices have been more portable and wireless in a rapid pace. For power sources for driving such electronic devices, there has been a strong demand for developing long life secondary batteries being small in size and light in weight and having a high energy density. Not only for use in small-sized consumer products but also for use in large-sized products such as power storage apparatuses and electric vehicles, the technological development for secondary batteries with high output characteristics, long-term durability, safety, and the like have been accelerated. Under these circumstances, greater attention has been placed on the development of non-aqueous electrolyte secondary batteries with high operating voltage and high energy density, particularly on lithium secondary batteries, to be used as power sources for electronic devices, power storage apparatuses, electric vehicles, and the like.

Non-aqueous electrolyte secondary batteries include a positive electrode, a negative electrode, a separator, and a non-aqueous electrolyte. The positive electrode contains a positive electrode active material. For the positive electrode active material, materials having a high potential versus lithium and being excellent in safety and synthesized in a comparatively easy manner, such as lithium cobalt oxide (LiCoO₂) and lithium nickel oxide (LiNiO₂), are used. The negative electrode contains a negative electrode active material, and for the negative electrode active material, various carbon materials such as graphite are used. The positive electrode and the negative electrode are typically produced by dissolving or dispersing the active material and a binder in an organic solvent to prepare a paste, then applying the paste onto a surface of a current collector such as metallic foil, and drying the paste. In this process, since the positive electrode active material is a metal oxide and is poor in electric conductivity, an electric conductive agent such as carbon black is used in combination with the positive electrode active material. The separator is disposed between the positive electrode and the negative electrode and is impregnated with the non-aqueous electrolyte. For the separator, a microporous film made of polyolefin is mainly used. For the non-aqueous electrolyte, for example, a liquid non-aqueous electrolyte obtained by dissolving a lithium salt such as LiBF₄ and LiPF₆ in an aprotic organic solvent is used.

For the positive electrode active material, a powdery material is typically used. The powder comprises secondary particles having an average particle size of about 10 to 20 μm, each secondary particle being an aggregate of a plurality of very fine primary particles having an average particle size of about 1 μm. In the positive electrode active material comprising aggregates of primary particles, the primary particles repeatedly expand and contract as the battery is charged and discharged. When the charge/discharge cycle is repeated, stress is applied to the grain boundaries between the primary particles due to the expansion and contraction of the primary particles, eventually causing the secondary particles to collapse. The primary particles present on the surfaces of the collapsed secondary particles can still contribute to the charge/discharge reaction, since the electric connection is ensured due to the contact with the conductive agent. In contrast, the primary particles present inside the collapsed secondary particles cannot contribute to the charge/discharge reaction, since the particles present inside are no more in contact with the primary particles on the surfaces as a result of the collapse and are not in contact with the conductive agent, thus being isolated from an electrically conductive network. As such, with the repetition of charge/discharge cycles, the battery capacity is reduced by an amount equivalent to that of the primary particles present inside the collapsed secondary particles.

In order to prevent the reduction in battery capacity, one proposal suggests, for example, as a positive electrode active material for a lithium secondary battery, a lithium-containing transition metal composite oxide having a basic composition represented by LiMeO₂, where Me is a transition metal, in which the particles constituting the oxide mainly composed of primary particles (see, for example, Patent Document 1). Patent Document 1 teaches that since almost no secondary particles are present, even when the primary particles expand or contact in association with charge and discharge, the reduction in capacity due to the collapse (being made finer) of secondary particles will not occur, resulting in an improvement of the charge/discharge cycle life characteristics of the battery.

However, by merely using primary particles as the positive electrode active material as disclosed in Patent Document 1, the reduction in battery capacity cannot be prevented, and thus the effect of improving the charge/discharge cycle life characteristics becomes insufficient. In particular, in order to impart conductivity uniformly to the active material whose surface area per unit weight has been increased because of being mainly composed of primary particles, a large amount of conductive agent is required. However, if a large amount of conductive agent is added, the mechanical strength, the capacity per volume, and the like of the positive electrode active material layer may be reduced.

Another proposal suggests a lithium secondary battery including a positive electrode active material comprising secondary particles obtained by aggregating primary particles of active material whose surfaces are coated with acetylene black (see, for example, Patent Document 2). Patent Document 2 teaches that if the secondary particles collapse into primary particles due to the expansion and contraction of the primary particles associated with charge and discharge, because of the coating of acetylene black on the surfaces of the primary particles, the primary particles present in the center of the secondary particles will not be isolated from the conductive network and can contribute to the charge/discharge reaction, resulting in improved life characteristics of the battery.

As a method of coating the primary particles with acetylene black, Patent Document 2 discloses a method comprising the steps of mixing primary particles with a dispersion in which acetylene black is dispersed in an organic solvent, drying the resultant mixture, and pulverizing the dried mixture. In this method, when spray drying is employed in drying, it is not necessary to perform the pulverizing. Patent Document 2 further discloses a method of adding secondary particles of positive electrode active material and acetylene black to an organic solvent, and performing the pulverizing of the secondary particles into primary particles and the coating of the primary particles with acetylene black simultaneously. It is disclosed that ball milling is employed in this method. In short, in Patent Document 2, the coating of the primary particles with acetylene black is performed by wet mixing.

However, in the case of wet mixing, although the primary particles are almost fully coated with acetylene black, the coated primary particles are easily reaggregated, and therefore, secondary particles are inevitably produced. If such secondary particles thus produced are repulverized into primary particles, the coating layers of acetylene black may be separated from the surfaces of the primary particles. Moreover, such repulverization is industrially disadvantageous. As such, according to the technique of Patent Document 2 also, it is impossible to avoid the collapse of secondary particles associated with charge and discharge. The collapse of secondary particles is unfavorable because it causes changes in volume of the positive electrode active material layer, and in association with the changes, the battery internal resistance, the battery capacity, and the like also change.

Patent Document 1: Japanese Laid-Open Patent Publication No. 2003-68300

Patent Document 2: Japanese Laid-Open Patent Publication No. Hei 11-329504

### DISCLOSURE OF THE INVENTION

### Problem to be Solved by the Invention

The present invention intends to provide: a positive electrode for a non-aqueous electrolyte secondary battery characterized by being capable of preventing the isolation of the positive electrode active material particles from the conductive network that occurs in association with charge and discharge, without the need of increasing the amount of the conductive agent, and thus being capable of contributing to achieving a higher output power and longer life of the battery; and a non-aqueous electrolyte secondary battery including this positive electrode.

### Means for Solving the Problem

The present inventors have conducted extensive studies in order to solve the above-discussed problem. As a result, the prevent inventors have conceived of a configuration in which the surfaces of primary particles of active material are coated with a conductive agent and, in an active material layer, 80% by weight or more of the total amount of the active material is present in the form of such primary particles. The present inventors have found that according to the foregoing configuration, the collapse of the active material in the form of secondary particles that occurs in association with repeated charge and discharge can be minimized, the changes in volume of the active material layer can be sufficiently suppressed, and the conductive network in the active material layer can be maintained at almost the same level as that at an early stage of the use of the battery for a long period of time; and thus completed the invention.

The present invention relates to a positive electrode for a non-aqueous electrolyte secondary battery comprising: an active material layer; and a current collector carrying the active material layer formed on at least one surface thereof, wherein the active material layer contains an active material, 80% by weight or more of a total amount of the active material being in the form of primary particles of the active material, and the primary particles of the active material have a conductive coating layer formed on the surface thereof.

It is preferable that the primary particles of the active material have a metal oxide layer containing a metal oxide different from the active material formed on the surface thereof, and further have the conductive coating layer ft/Hied on the surface of the metal oxide layer.

It is preferable that the conductive coating layer is formed on the surface of the primary particles of the active material by dry mixing of the primary particles of the active material and a conductive agent.

It is preferable that the dry mixing is performed by a mechanochemical method.

It is preferable that the active material layer contains the active material, 80% by weight or more of a total amount of the active material being in the form of primary particles of the active material, the primary particles of the active material have a conductive coating layer formed on the surface thereof, and the active material layer further contains a conducive agent.

The present invention further relates to a non-aqueous electrolyte secondary battery comprising: an electrode assembly including the positive electrode for a non-aqueous electrolyte secondary battery of the present invention, a negative electrode containing an active material capable of absorbing and desorbing lithium ions, and a separator; and a non-aqueous electrolyte.

### EFFECT OF THE INVENTION

According to the present invention, by allowing the primary particles of active material whose surfaces are coated with a conductive agent to be present in the active material layer in the form of primary particles themselves, even when charge and discharge are repeated, it is possible to significantly reduce the collapse of active material in the form of secondary particles as well as the changes in volume of the active material layer associated with the collapse. As a result, the isolation of the active material particles from the conductive network in the active material layer is unlikely to occur. As such, the positive electrode for a non-aqueous electrolyte secondary battery of the present invention can contribute to achieve a higher output power and longer life of the non-aqueous electrolyte secondary battery. Further, by utilizing the positive electrode of the present invention, it is possible to provide a non-aqueous electrolyte secondary battery that has a high output power, exhibits little reduction in output power even after repeated charge and discharge, and can be used for a longer period of time than conventional non-aqueous electrolyte batteries.

### BRIEF DESCRIPTION OF THE DRAWINGS

FIG. 1 is a longitudinal sectional view schematically illustrating a configuration of a positive electrode according to an embodiment of the present invention;

FIG. 2 is a scanning electron micrograph showing a surface of the active material layer in the positive electrode shown in FIG. 1;

FIG. 3 is a scanning electron micrograph showing a surface of the active material layer in a conventional positive electrode;

FIG. 4 is a longitudinal sectional view schematically illustrating a configuration of a positive electrode according to another embodiment of the present invention;

FIG. 5 is a longitudinal sectional view schematically illustrating a configuration of a non-aqueous electrolyte secondary battery according to yet another embodiment of the present invention;

FIG. 6 is a graph showing a pattern of pulse charge and pulse discharge at a constant current in an output characteristic test;

FIG. 7 is a graph showing the relationship between a current and a voltage during discharge in a battery; and

FIG. 8 is a graph showing the cycle characteristics of batteries of Examples 1 to 5 and Comparative Examples 1 to 3.

### BEST MODE FOR CARRYING OUT THE INVENTION

### Positive Electrode for Non-Aqueous Electrolyte Secondary Battery

A positive electrode for a non-aqueous electrolyte secondary battery of the present invention (hereinafter simply referred to as a “positive electrode”) is characterized in that in an active material layer, 80% by weight or more of the total amount of the active material is present in the form of primary particles, and the primary particles of the active material each have a conductive coating layer on the surface thereof.

The higher the content of the primary particles in the active material is, the more preferable it is, as long as the content is 80% by weight or more. Particularly preferable is that 100% of the total amount of the active material is in the form of primary particles. When the content of the active material in the form of primary particles is less than 80% by weight, the content of the active material in the form of secondary particles is relatively large. As a result, repeated charge and discharge will result in a significant collapse of the active material in the form of secondary particles and significant changes in volume of the active material layer associated with the collapse, and therefore the conductive network in the active material layer may not be ensured sufficiently.

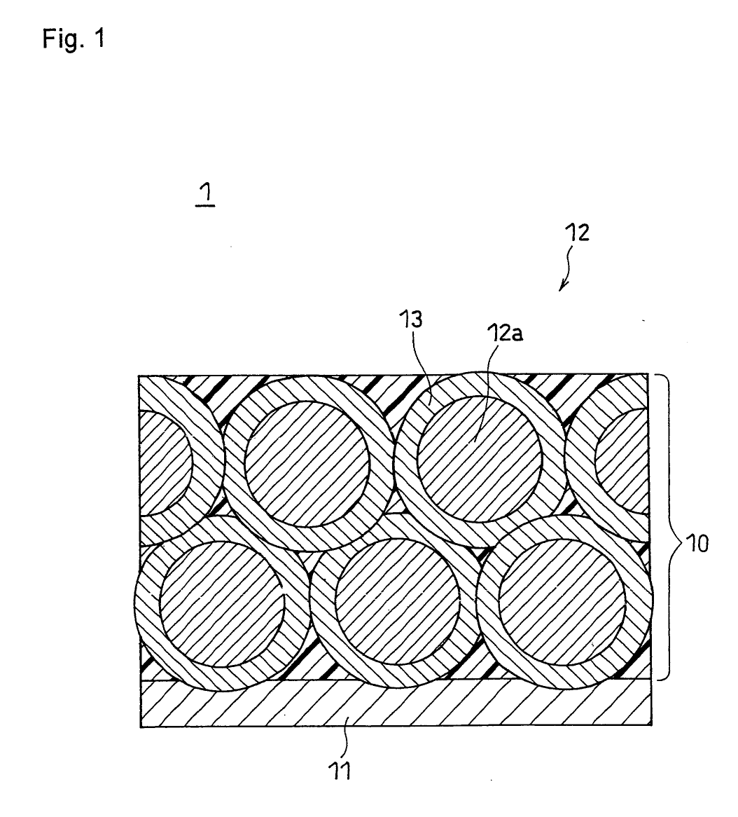

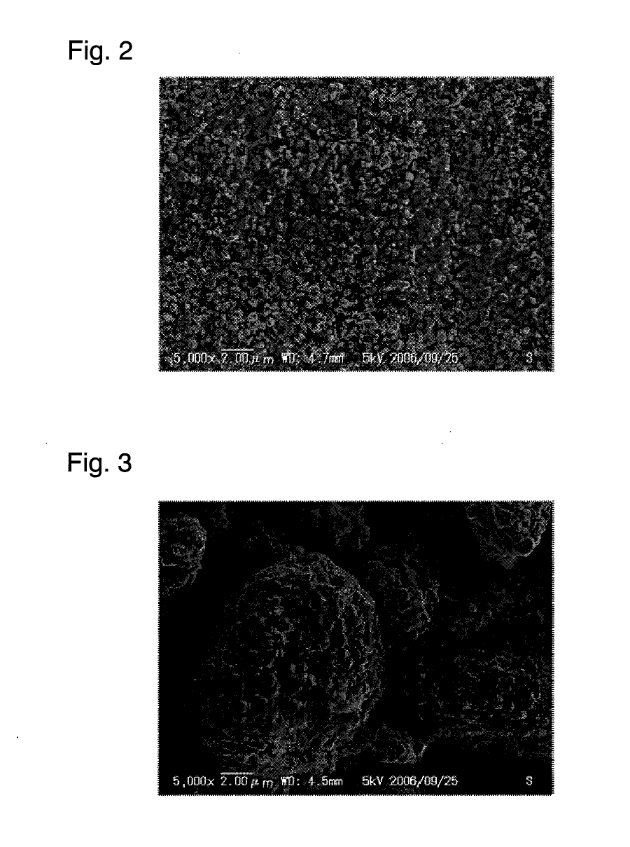

FIG. 1 is a longitudinal sectional view schematically illustrating a configuration of a positive electrode 1 according to an embodiment of the present invention. FIG. 2 is a scanning electron micrograph (SEM) showing a surface of an active material layer 10 in the positive electrode 1 illustrated in FIG. 1. FIG. 3 is a scanning electron micrograph (SEM) showing a surface of the active material layer in a conventional positive electrode. Note that in the conventional positive electrode illustrated in FIG. 3, 100% of the total amount of the active material contained in the active material layer is in the form of secondary particles.

The positive electrode 1 includes the active material layer 10 and a current collector 11. From FIGS. 2 and 3, the following is clear: the active material layer 10 in the positive electrode 1 has a very smooth surface, since 80% by weight or more of the total amount of the active material contained therein is in the form of primary particles; whereas the active material layer in the conventional positive electrode has a noticeably rough surface, since 100% of the total amount of the active material is in the form of secondary particles.

The active material layer 10 is provided on at least one surface of the current collector 11 and contains an active material 12, and as needed, a conductive agent, a binder, and the like.

In the active material 12, 80% by weight or more of the total amount is primary particles 12a with the remainder being secondary particles. The primary particles 12a of the active material 12 each have a conductive coating layer 13 on the surface thereof. Here, it is not necessary that the conductive coating layer 13 should cover the entire surface of the primary particle 12a. In the present invention, the primary particles 12a are particles that are present independently from one another without being aggregated or bonded into secondary particles. The secondary particles may be particles that are formed into secondary particles after the formation of the conductive coating layer on the surfaces of the primary particles, or alternatively be secondary particles with the conductive coating layer formed on the surfaces thereof.

As the active material 12, a positive electrode active material commonly used in the field of non-aqueous electrolyte secondary batteries may be used, among examples of which a lithium composite metal oxide is preferable. Examples of the lithium composite metal oxide include LiₓCoO₂, LiₓNiO₂, LiₓMnO₂, LiₓCO_{y}Ni_{1-y}O_{z}, LiₓCo_{y}M_{1-y}O_{z}, LiₓNi_{1-y}M_{y}O_{z}, LiₓMn₂O₄, LiₓMn_{2-y}M_{y}O₄, LiMPO₄, Li₂MPO₄F, where M is at least one element selected from the group consisting of Na, Mg, Sc, Y, Mn, Fe, Co, Ni, Cu, Zn, Al, Cr, Pb, Sb, and B; x=0 to 1.2, y=0 to 0.9, and z=2.0 to 2.3; x is a value upon production of the active material and increases and decreases during charge and discharge. Further, part of each of these lithium composite metal oxides may be substituted by a different element. These may be used alone or in combination of two or more as the active material 12.

The average particle size of the primary particles 12a of the active material 12 is preferably 0.1 to 10 μm, and more preferably 0.3 to 5 μm. When the average particle size of the primary particles 12a is less than 0.1 μm, the packing density of the active material 12 in the active material layer 10 is not satisfactorily high, and the capacity density of the non-aqueous electrolyte secondary battery to be obtained may become insufficient. On the other hand, when the average particle size of the primary particles 12a exceeds 10 μm, the output characteristics of the active material 12 may be deteriorated. The particle size of the primary particles 12a herein refers to an average particle size by volume measured using a laser diffraction-type particle size distribution meter (trade name: MT-3000, available from Nikkiso Co., Ltd.) by a laser diffraction scattering method (Microtrack). The content (% by weight) of the primary particles to the total amount of the active material is also measured using the laser diffraction-type particle size distribution meter (trade name: MT-3000).

The primary particles 12a of the active material 12 may be produced, for example, according to a known method, such as a solid phase reaction method, a precipitation method, a molten salt method, an atomizing combustion method, and a pulverizing method, or a combination of two or more of these methods. For example, according to the solid phase reaction method, the primary particles 12a are obtained by mixing raw material powders and baking the mixture. According to the precipitation method, the primary particles 12a are precipitated out of a solution. According to the pulverizing method, the primary particles are obtained by applying a mechanical stress to secondary particles synthesized by a conventional method. The mechanical stress is applied using, for example, a dry or wet ball mill, an oscillation mill, a jet mill, and the like. Specifically, for example, secondary particles of active material are pulverized in a planetary ball mill in the presence of a medium such as zirconia beads, whereby the secondary particles are pulverized, and the primary particles 12a are obtained. It should be noted that in the case where only the pulverization of secondary particles is performed, using a medium such as zirconia beads makes it possible to prevent the produced primary particles from being reaggregated into secondary particles.

A method of forming the conductive coating layer 13 on the surfaces of the primary particles 12a of the active material 12 is not particularly limited, but a method of dry mixing the primary particles 12a of the active material 12 with a conductive agent is preferable. By using this method, the surfaces of the primary particles 12a of the active material 12 are coated with the conducive agent, and it is possible to almost selectively obtain primary particles only that are unlikely to be reaggregated into secondary particles and each have a conductive coating layer formed on its surface. The dry mixing is preferably performed by a mechanochemical method. The mechanochemical method is a method of applying mechanical energy of compression, friction, impact, and the like to a powder to modify the powder. Various apparatuses enabling the mechanochemical method are commercially available, examples of which include a circulation-type mechanofusion system (trade name, available from Hosokawa Micron Corporation). According to the mechanochemical method, the conductive coating layer 13 is formed on the surfaces of the primary particles 12a of the active material 12 by, for example, applying mechanical energy of compression, friction, impact, and the like to a mixture of the primary particles of the active material 12 and a conductive agent.

For the conductive agent to be used in forming the conductive coating layer 13, for example, graphites; carbon blacks such as acetylene black, Ketjen black, furnace black, lampblack and thermal black; and conductive fibers such as carbon fiber and metal fiber may be used. These may be used alone or in combination of two or more. The amount of the conductive agent used is not particularly limited, but is preferably 1 to 20 parts by weight per 100 parts by weight of primary particles of the active material 12, and more preferably 1 to 10 parts by weight. Selecting an amount of the conductive agent used from within the foregoing range makes it possible not only to merely improve the output characteristics and the life characteristics of the battery in a well-balanced manner but also to improve the packing ability of the active material 12 into the active material layer 10, thereby to achieve a higher battery capacity as well. When the amount of the conductive agent used is less than 1 part by weight, the conductive network in the active material layer 10 may not be sufficiently established, and the primary particles 12a may be partially isolated from the conductive network. When the amount of the conductive agent used exceeds 20 parts by weight, the mechanical strength, the capacity per volume, and the like of the active material layer 10 may be reduced.

In the active material layer 10, separately from the conductive agent coating the primary particles 12a of the active material 12, a conductive agent may be co-present with the active material 12.

The conductive agent co-present with the active material is brought into contact with the conductive coating layer 13 provided on the surfaces of the primary particles 12a of the active material 12. This further improves the conductivity of the active material layer 10. In addition, by virtue of this, even if the volume of the active material layer 10 is changed in association with repeated charge and discharge, the conductive network in the active material layer 12 is ensured with the aid of the conductive agent co-present. For this reason, provided that the total amounts of the conductive agent used are the same, the conductivity in the active material layer 10 obtained when the conductive coating layer 13 is formed and the conductive agent is allowed to be present in the active material layer 10 is higher than that obtained when the conductive agent is contained only in the conductive coating layer 13. As a result, a higher output power of the battery can be obtained.

As the conductive agent to be co-present with the active material 12 in the active material layer 10, the same conductive agent coating the primary particle 12a of the active material 12 may be used. The conductive agent is preferably used in such a manner that the total amount of the conductive agent co-present and the conductive agent used in the conductive coating layer 13 is 1 to 20 parts by weight per 100 parts by weight of primary particles of the active material 12. When the conductive agent is used within the foregoing range, it is possible not only to merely improve the output characteristics and the life characteristics of the battery in a well-balanced manner but also to improve the packing ability of the active material 12, thereby to achieve a higher battery capacity as well.

As the binder, a binder commonly used in the field of non-aqueous electrolyte secondary batteries may be used, examples of which include fluorocarbon resin, such as polytetrafluoroethylene, polyvinylidene fluoride (PVDF) and modified materials thereof, tetrafluoroethylene-hexafluoropropylene copolymer (FEP), and vinylidene fluoride-hexafluoropropylene copolymer; and polyolefin, such as polyethylene, and polypropylene. The amount of the binder used is not particularly limited, but is preferably 1 to 10 parts by weight per 100 parts by weight of the active material 12.

The active material layer 10 may be formed by, for example, dissolving or dispersing the active material 12, and as needed, the conductive agent, the binder, and like in a dispersion medium to prepare a positive electrode material mixture slurry, applying the prepared positive electrode material mixture slurry onto a surface of the current collector 11, and drying the slurry, followed by rolling, whereby the positive electrode 1 is obtained. Examples of the dispersion medium include amides, such as N,N-dimethylformamide, dimethylacetamide, methylformamide, hexamethylsulfonylamide, and tetramethylurea; amines, such as N-methyl-2-pyrrolidone (NMP), and dimethylamine; ketones, such as methylethylketone, acetone, and cyclohexanone; and ethers, such as tetrahydrofuran; sulfoxides, such as dimethylsulfoxide. The rolling is performed once to five times at a predetermined pressure. The active material density in the active material layer 10 is preferably 1.8 to 3.8 g/cm³, and preferably, the rolling is performed so that the active material density falls within the foregoing range.

As the current collector 11, a current collector commonly used in this field may be used, examples of which include a conductive substrate made of stainless steel, aluminum, titanium, or the like. The conductive substrate may be in the form of foil, film, sheet, woven fabric, nonwoven fabric, and the like. Further, the conductive substrate may be porous or non-porous. The thickness of the current collector 11 is not particularly limited, but is preferably 1 to 50 μm, and more preferably 5 to 30 μm.

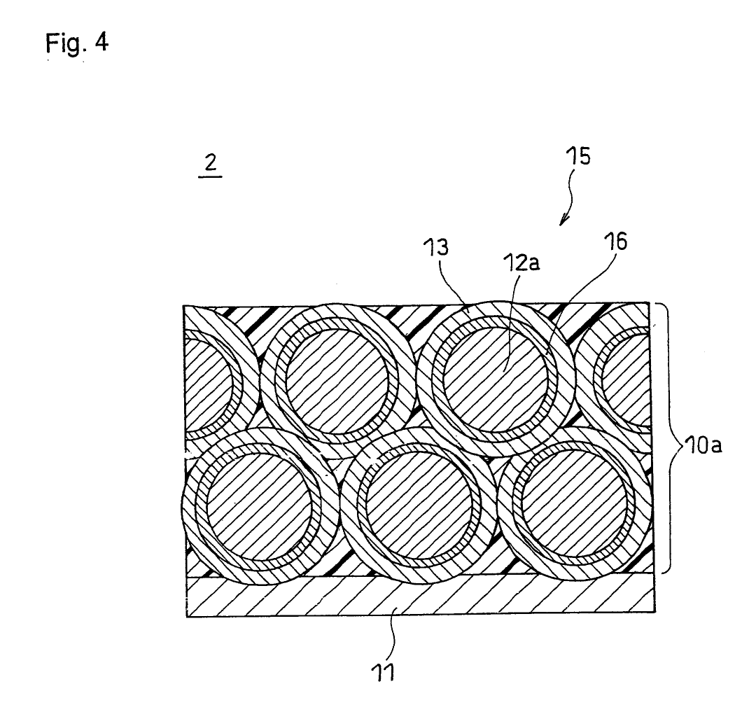

FIG. 4 is a longitudinal sectional view schematically illustrating a configuration of a positive electrode 2 according to another embodiment of the present invention. The positive electrode 2 is analogous to the positive electrode 1, and the corresponding parts thereof are designated by the same reference numerals and the description thereof may be omitted. The positive electrode 2 is characterized in that an active material layer 10a contains an active material 15 in place of the active material 12.

The active material 15 is similar to the active material 12 in that 80% by weight or more of the total amount thereof is the primary particles 12a with the remainder being secondary particles, but different from the active material 12 in that a metal oxide layer 16 and the conductive coating layer 13 are formed in this order on the surfaces of the primary particles 12a.

By providing the metal oxide layer 16 on the surfaces of the primary particles 12a of the active material 15, it is possible to inhibit the decomposition reaction of the non-aqueous electrolyte on the surface of the active material 15, and to further improve the battery life. The metal oxide contained in the metal oxide layer 16 should be different from that used as the active material 15. A preferable example of the metal oxide is a compound that is inactive in the battery and chemically stable. Being inactive in the battery herein refers to a state in which, while the compound is being in contact with the non-aqueous electrolyte, under redox potentials, or under other conditions, there occurs no side reaction adversely affecting the battery characteristics, causing no malfunction of the battery. Examples of the metal oxide include alumina, zeolite, silicon nitride, silicon carbide, titanium oxide, zirconium oxide, magnesium oxide, zinc oxide, and silicon dioxide. More preferably, the metal oxide has a high purity. These metal oxides may be used alone or in combination of two or more.

Here, it is not necessary that the metal oxide layer 16 should cover the entire surface of the primary particle 12a, and may cover a part thereof. The metal oxide layer 16 may be formed in the similar manner to the conductive coating layer 13 on the primary particle 12a of the active material 15. The amount of the metal oxide used is preferably 1 to 20 parts by weight per 100 parts by weight of the primary particles 12a of the active material 15, and more preferably 1 to 10 parts by weight. Selecting an amount of the metal oxide used from within the foregoing range makes it possible not only to merely improve the output characteristics and the life characteristics of the battery in a well-balanced manner but also to improve the packing ability of the active material 15 into the active material layer 10a, thereby to achieve a higher battery capacity as well.

After the metal oxide layer 16 is formed, the conductive coating layer 13 is formed, whereby the metal oxide layer 16 and the conductive coating layer 13 are formed in this order on the surfaces of the primary particles 12a of the active material 15.

The positive electrodes 1 and 2 of the present invention having the configuration as described above are excellent in both output characteristics and life characteristics, and therefore, capable of providing a non-aqueous electrolyte secondary battery with good performance. [Non-aqueous electrolyte secondary battery]

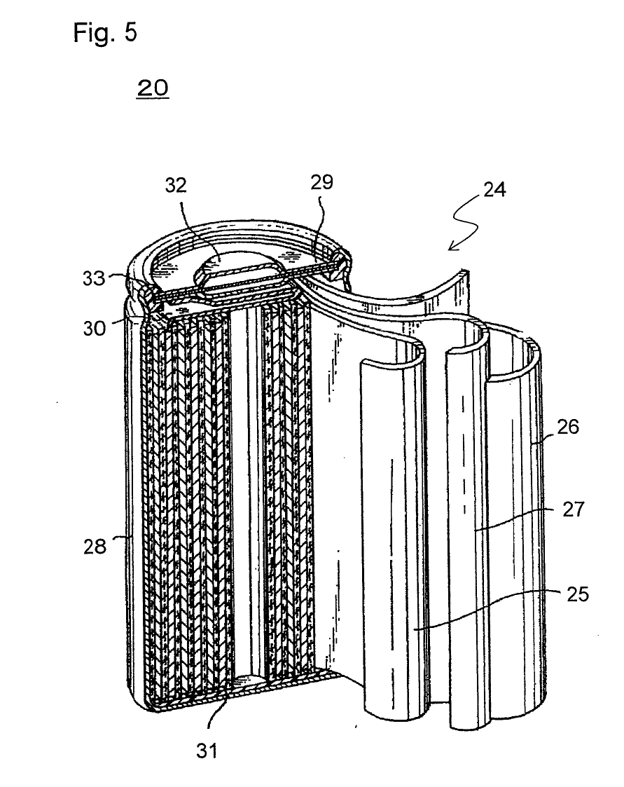

The non-aqueous electrolyte secondary battery of the present invention is characterized by using the positive electrode of the present invention, and may have the same configuration as a conventional non-aqueous electrolyte secondary battery except the above. An example of the non-aqueous electrolyte secondary battery of the present invention is shown in FIG. 5.

FIG. 5 is a longitudinal partial sectional view schematically illustrating a configuration of a non-aqueous electrolyte secondary battery 20 according to yet another embodiment of the present invention. The non-aqueous electrolyte secondary battery 20 is a cylindrical battery including a positive electrode 25, a negative electrode 26, a separator 27, a battery case 28, a sealing plate 29, and a non-aqueous electrolyte (not illustrated). The positive electrode 25 and the negative electrode 26 are stacked with the separator 27 interposed therebetween, and then wound into a cylindrical shape, whereby a wound electrode assembly 24 is configured.

The positive electrode 25 is disposed so as to face the negative electrode 26 with the separator 27 interposed therebetween. The positive electrode 25 may be the positive electrode of the present invention.

The negative electrode 26 includes a negative electrode current collector (not illustrated) and a negative electrode active material layer (not illustrated).

For the negative electrode current collector, a conductive substrate made of stainless steel, nickel, copper, copper alloy, or the like may be used. The conductive substrate may be in the form of foil, film, sheet, woven fabric, nonwoven fabric, and the like. Further, the conductive substrate may be porous or non-porous. The thickness of the negative electrode current collector is not particularly limited, but is preferably 1 to 50 μm, and more preferably 5 to 20 μm. Selecting a thickness of the negative electrode current collector from within the foregoing range makes it possible to reduce the weight of the negative electrode 26 while maintaining its strength.

The negative electrode active material layer is provided on one or both surfaces of the negative electrode current collector, contains a negative electrode active material capable of absorbing and desorbing lithium ions, and further contains, as needed, a binder, a thickener, and the like. As the negative electrode active material, a negative electrode active material commonly used in the field of non-aqueous electrolyte secondary batteries may be used, examples of which include a metal material, a carbon material, an oxide, a nitride, a tin compound, and a silicide, and a composite material containing two or more of these. Examples of the metal material include lithium and lithium alloy. The metal material may be in the form of particles, a plate, fibers, and the like. Examples of the carbon material include various natural graphites, coke, carbon fiber, spherical carbon, various artificial graphites, and amorphous carbon. These negative electrode active materials may be used alone or in combination of two or more.

As the binder, a binder commonly used in the field of non-aqueous electrolyte secondary batteries may be used, examples of which include fluorocarbon resin, such as PVDF and modified materials thereof, FEP, and vinylidene fluoride-hexafluoropropylene copolymer; rubber particles such as styrene-butadiene rubber; and polyolefin, such as, polyethylene, and polypropylene. The amount of the binder used is not particularly limited, but is preferably 0.5 to 10 parts by weight per 100 parts by weight of the negative electrode active material.

As the thickener, a thickener commonly used in this field may be used, examples of which include ethylene-vinyl alcohol copolymer, carboxymethylcellulose, and methylcellulose.

The negative active material layer may be formed by, for example, dissolving or dispersing the negative electrode active material, and as needed, the binder, the thickener, and like in a dispersion medium to prepare a negative electrode material mixture slurry, applying the prepared slurry onto at least one surface of the negative electrode current collector, and drying the slurry, followed by rolling, whereby the negative electrode 26 is obtained. The dispersion medium may be the same dispersion medium as used in preparing the positive electrode material mixture slurry, and may be water.

The separator 27 is disposed so as to be sandwiched between the positive electrode 25 and the negative electrode 26.

For the separator 27, a microporous thin film, woven fabric, nonwoven fabric, and the like that are excellent in ion permeability and have both a predetermined mechanical strength and an insulating property may be used. The separator 27 is preferably made of, for example, polyolefin such as polypropylene and polyethylene, because of its excellent durability and its shut-down function. The thickness of the separator 27 is generally 10 to 300 μm, but is usually 40 μm or less, preferably 5 to 30 μm, and more preferably 10 to 25 μm. The separator 27 may be of a single layer film made of one material, or alternatively, a composite or multilayer film made of two or more materials. The range of the porosity of the separator 27 is preferably from 30 to 70%, and more preferably from 35 to 60%. The porosity herein refers to the ratio of a volume of pores to a volume of the separator 27.

For the non-aqueous electrolyte, an electrolyte in a liquid, gelled, or solid (polymer solid electrolyte) state may be used.

The non-aqueous electrolyte in a liquid state (non-aqueous electrolyte solution) is obtained by dissolving a supporting salt (solute) in a non-aqueous solvent. As the non-aqueous solvent, a non-aqueous solvent commonly used in this field may be used, examples of which include a cyclic carbonic acid ester, a chain carbonic acid ester, and a cyclic carboxylic acid ester. Examples of the cyclic carbonic acid ester include propylene carbonate (PC), ethylene carbonate (EC) and the like. Examples of the chain carbonic acid ester include diethyl carbonate (DEC), ethyl methyl carbonate (EMC), dimethyl carbonate (DMC) and the like. Examples of the cyclic carboxylic acid ester include γ-butyrolactone (GBL), γ-valerolactone (GVL) and the like. These non-aqueous solvents may used alone or in combination of two or more.

Examples of the supporting salt include LiClO₄, LiBF₄, LiPF₆, LiAlCl₄, LiSbF₆, LiSCN, LiCF₃SO₃ LiCF₃CO₂, Li (CF₃SO₂)₂, LiAsF₆, LiB₁₀Cl₁₀, lithium lower aliphatic carboxylate, LiCl, LiBr, LiI, chloroborane lithium, boric acid salts, and imide salts. Examples of the boric acid salts include lithium bis(1,2-benzendioleate(2-)-O,O′) borate, lithium bis(2,3-naphthalenedioleate(2-)-O,O′) borate, lithium bis(2,2-biphenyldioleate(2-)-O,O′) borate, and lithium bis(5-fluoro-2-oleate-1-benzenesulfonate-O,O′) borate. Examples of the imide salts include lithium bis(trifluoromethanesulfonyl)imide ((CF₃SO₂)₂NLi), lithium (trifluoromethanesulfonyl) (nonafluorobutanesulfonyl)imide (LiN(CF₃SO₂) (C₄F₉SO₂)), and lithium bis(pentafluoroethanesulfonyl)imide ((C₂F₅SO₂)₂NLi). These solutes may be used alone or in combination of two or more. The amount of the supporting salt to be dissolved in the non-aqueous solvent is preferably 0.5 to 2 mol/L.

The non-aqueous electrolyte solution preferably contains a cyclic carbonic acid ester having at least one carbon-carbon unsaturated bond. Such a cyclic carbonic acid ester decomposes on the negative electrode 26 to form a coating film having a high lithium ion conductivity. This improves the charge/discharge efficiency. Examples of the cyclic carbonic acid ester having at least one carbon-carbon unsaturated bond include vinylene carbonate (VC), 3-methyl vinylene carbonate, 3,4-dimethyl vinylene carbonate, 3-ethyl vinylene carbonate, 3,4-diethyl vinylene carbonate, 3-propyl vinylene carbonate, 3,4-dipropyl vinylene carbonate, 3-phenyl vinylene carbonate, 3,4-diphenyl vinylene carbonate, vinyl ethylene carbonate (VEC), and divinyl ethylene carbonate. Among these, vinylene carbonate, vinyl ethylene carbonate, divinyl ethylene carbonate, and the like are preferable. The above cyclic carbonic acid esters may be used alone or in combination of two or more. It should be noted that in the above cyclic carbonic acid esters, part of hydrogen atoms may be substituted by fluorine atoms.

The non-aqueous electrolyte solution may further contain a benzene derivative that decomposes during overcharge to form a coating film on the electrode, and inactivates the battery. As the benzene derivative, any compound may be used without any particular limitation as long as it has a benzene ring in its molecule, but a compound having a phenyl group and a cyclic compound group adjacent to the phenyl group is preferable. As the cyclic compound group, a phenyl group, a cyclic ether group, a cyclic ester group, a cycloalkyl group, a phenoxy group, and the like are preferable. Examples of the benzene derivative include cyclohexylbenzene, biphenyl, diphenyl ether, and the like. These benzene derivatives may be used alone or in combination of two or more. The content of the benzene derivative is preferably 10% by volume or less of the entire non-aqueous solvent.

The non-aqueous electrolyte in a gelled state includes a non-aqueous electrolyte solution and a polymer material capable of retaining the non-aqueous electrolyte solution. For such a polymer material, for example, polyvinylidene fluoride, polyacrylonitrile, polyethylene oxide, polyvinyl chloride, polyacrylate, and polyvinylidene fluoride hexafluoropropylene are suitably used.

The non-aqueous electrolyte in a solid state includes a solute (supporting salt) and a polymer material. The solute may be the same solute as listed above. Examples of the polymer material include polyethylene oxide (PEO), polypropylene oxide (PPO), and a copolymer of ethylene oxide and propylene oxide.

A battery case 28 is a bottomed cylindrical container with one end thereof in the longitudinal direction being open. The battery case 28 is made of, for example, iron, and to the outer and/or inner surface thereof, plating such as gloss nickel plating, semi-gloss nickel plating, and nickel plating may applied. A sealing plate 29 seals the opening of the battery case 28 and is provided with a positive terminal 32.

The non-aqueous electrolyte secondary battery 20 is produced, for example, in the following manner. First, one end of a positive electrode lead 30 is connected to a positive electrode current collector (not illustrated) of the positive electrode 25. The positive electrode lead 30 is made of, for example, aluminum. On the other hand, one end of a negative electrode lead 31 is connected to the negative electrode current collector (not illustrated) of the negative electrode 26. The negative electrode lead 31 is made of, for example, nickel. Next, the positive electrode 25 and the negative electrode 26 are wound with the separator 27 interposed therebetween, whereby the wound electrode assembly 24 is fabricated. The wound electrode assembly 24 thus fabricated is housed inside the battery case 28.

The other end of the positive electrode lead 30 is connected to the sealing plate 29, and the other end of the negative electrode lead 31 is connected to the bottom of the battery case 28. The bottom of the battery case 28 serves as a negative electrode terminal. This battery case 28 is inserted into a battery outer case (not illustrated), and then, the non-aqueous electrolyte solution is injected into the battery case 28 under a reduced pressure. The sealing plate 29 is placed on the opening of the battery case 28 with a gasket 33 interposed therebetween, and the opening end of the battery case 20 is crimped onto the sealing plate 29, to seal the battery case 28. In such a manner, the non-aqueous electrolyte secondary battery 20 is provided.

In addition, between the wound electrode assembly 24 and the sealing plate 29, an upper insulator plate made of resin (not illustrated) is disposed as needed. Further, between the wound electrode assembly 24 and the bottom of the battery case 28, a lower insulator plate made of resin (not illustrated) is disposed as needed.

The non-aqueous electrolyte secondary battery of the present invention is not limited to of a cylindrical type, and may be fabricated into various types, such as a prismatic type, a coin type, a button type, a laminate type, and the like.

The present invention is specifically described with reference to examples and comparative examples.

### Example 1

### (1) Production of Positive Electrode Active Material

To an aqueous NiSO₄ solution, sulfates of Co and Al were added such that the molar ratio of Ni:Co:Al was 7:2:1, to prepare an aqueous saturated solution, and then a sodium hydroxide solution was gradually added dropwise to the resultant aqueous saturated solution while being stirred, to neutralize the solution, whereby a ternary precipitate represented by Ni_{0.7}Co_{0.2}Al_{0.1}(OH)₂ was produced by coprecipitation. The produced precipitate was collected by filtration, washed with water, and dried at 80° C., to give a composite hydroxide. The volume average particle size of the composite hydroxide thus obtained was measured with a particle size distribution meter (trade name: MT3000, available from Nikkiso Co., Ltd.). The result found that the volume average particle size was 12 μm.

This composite hydroxide was heated at 900° C. in air for 10 hours, to give a ternary composite oxide represented by Ni_{0.7}CO_{0.2}Al_{0.1}O. The structure of the composite oxide thus obtained was evaluated by powder X-ray diffractometry. The result found that the structure thereof was the same as that of a single-phase nickel oxide. Subsequently, the composite oxide was mixed with a monohydrate of lithium hydroxide such that the total number of Ni, Co and Al atoms became equal to the number of Li atoms, and heated at 800° C. in air for 10 hours, to give a lithium nickel composite oxide represented by LiNi_{0.7}Co_{0.2}Al_{0.1}O₂.

The structure of the lithium nickel composite oxide thus obtained was evaluated by powder X-ray diffractometry. The result found that the structure thereof was a single-phase hexagonal layered structure, and Co and Al were dissolved therein. The lithium nickel composite oxide was pulverized and classified, to give secondary particles of positive electrode active material having an average particle size of 12.4 μm and a specific surface area measured by BET method of 0.45 m²/g. The secondary particles thus obtained were observed under a scanning electron microscope (SEM). The result found that the primary particles constituting the secondary particles were about 1 μm in size.

This positive electrode composite oxide and an N-methyl-2-pyrrolidone (NMP) solvent were mixed in the ratio of 100:200 parts by weight, and the resultant mixture was pulverized for 2 hours in a planetary ball mill using zirconia beads of 2 mm in diameter. The measurement of particle size distribution revealed that the average particle size was 0.85 μm, and the SEM observation revealed that the secondary particles were pulverized into primary particles.

Subsequently, 100 parts by weight of the primary particles of positive electrode active material obtained in the above and 3 parts by weight of acetylene black were dry-mixed for 30 minutes in a circulation-type mechanofusion system (trade name, available from Hosokawa Micron Corporation) with the stator clearance being set to 5 mm and the load being set to 20 kW. The resultant mixture was observed under a scanning electron microscope (SEM). As a result, the formation of composite primary particles in which the conductive coating layer made of acetylene black was formed on the surfaces of the primary particles of positive electrode active material was observed, but no aggregate of the foregoing composite primary particles (i.e., secondary particle) was observed.

### (2) Production of Positive Electrode

First, 3 kg of the composite primary particles obtained in the above and 1000 g of polyvinylidene fluoride solution (trade name: KF1320, available from Kureha Corporation) were kneaded together with an appropriate amount of NMP in a planetary mixer, to give a positive electrode material mixture slurry. The positive electrode material mixture slurry thus obtained was applied onto a 15-μm-thick aluminum foil, and dried. Subsequently, the aluminum foil with the dried slurry was rolled until the overall thickness reached 100 μm, and cut into an electrode sheet having a width of 52 mm. To the center of the electrode sheet, one end of a 5-mm-wide positive electrode lead made of aluminum was bonded, whereby a positive electrode was produced.

### (3) Production of Negative Electrode

First, 3 kg of artificial graphite (negative electrode active material), 75 g of styrene-butadiene copolymer rubber particle binder (trade name: BM-400B, solid content: 40% by weight, available from Zeon Corporation, Japan), 30 g of carboxymethylcellulose (thickener), and an appropriate amount of water were kneaded together in a planetary mixer, to give a negative electrode material mixture slurry. The negative electrode material mixture slurry thus obtained was applied onto a 10-μm-thick copper foil, and dried. Subsequently, the copper foil with the dried slurry was pressed until the overall thickness reached 110 μm, and cut into an electrode sheet having a width of 55 mm. To each of both ends of the electrode sheet, one end of a 5-mm-wide negative electrode lead made of nickel was bonded, whereby a negative electrode was produced.

### (4) Production of Electrode Assembly

The positive electrode and the negative electrode obtained in the above were wound with a polyethylene separator (model No. 0540, available from Asahi Kasei Chemicals Corporation) interposed therebetween into a cylindrical shape with the positive and negative electrode current collectors being exposed at both ends thereof, whereby a wound electrode assembly (diameter: 17 mm, length: 60 mm) was produced.

### (5) Preparation of Non-aqueous Electrolyte Solution

To a mixed solvent containing ethylene carbonate and ethyl methyl carbonate in a volume ratio of 1:3, 1% by weight of vinylene carbonate was added, and then LiPF₆ was dissolved therein in a concentration of 1.0 mol/L, whereby a non-aqueous electrolyte solution was prepared.

### (6) Fabrication of Cylindrical Non-aqueous Electrolyte Secondary Battery

The wound electrode assembly was inserted into a bottomed cylindrical battery case having a diameter of 18 mm and a height of 65 mm. The other end of the positive electrode lead was connected to a sealing plate, and the other ends of the negative electrode leads were connected to the bottom of the battery case. This battery case was inserted into a cylindrical outer jacket made of plastic, and then 5.2 mL of the non-aqueous electrolyte was injected into the battery case. The opening end of the battery case was crimped so that the sealing plate was fixed and the battery case was sealed, whereby a non-aqueous electrolyte secondary battery (design capacity: 1200 mAh) of the present invention was fabricated.

### Example 2

Primary particles of positive electrode active material were produced in the same manner as in Example 1. Subsequently, 100 parts by weight of the primary particles of positive electrode active material and 3 parts by weight of alumina (Al₂O₃, metal oxide) were mixed for 30 minutes in the circulation-type mechanofusion system. To the resultant mixture, 3 parts by weight of acetylene black was added and mixed for 30 minutes in the circulation-type mechanofusion system, to give composite primary particles. The operating conditions of the circulation-type mechanofusion system were the same as those in Example 1 in both steps. The composite primary particles thus obtained were observed under a scanning electron microscope, and as a result, no aggregate of the foregoing composite primary particles (i.e., secondary particle) was observed.

The non-aqueous electrolyte secondary battery of the present invention was fabricated in the same manner as in Example 1 except that the composite primary particles thus obtained was used in place of the composite primary particles of Example 1.

### Example 3

Composite primary particles were produced in the same manner in Example 1. Next, 3.09 kg of the composite primary particles, 1000 g of polyvinylidene fluoride solution (KF1320), 60 g of acetylene black, and an appropriate amount of NMP were kneaded together in a planetary mixer, to give a positive electrode material mixture slurry. Here, based on the total of the amount of the conductive agent coating the surface of the positive electrode active material and the amount of the conductive agent contained in the positive electrode material mixture slurry, the conductive agent was used in a ratio of 5 parts by weight per 100 parts by weight of the positive electrode active material.

The non-aqueous electrolyte secondary battery of the present invention was fabricated in the same manner as in Example 1 except that the positive electrode material mixture slurry thus obtained was used in place of the positive electrode material mixture slurry of Example 1.

### Example 4

Primary particles of positive electrode active material were produced in the same manner as in Example 1. Subsequently, 100 parts by weight of the primary particles of positive electrode active material and 5 parts by weight of acetylene black were dry-mixed for 60 minutes in the circulation-type mechanofusion system under the same conditions with those in Example 1. The resultant mixture was observed under a scanning electron microscope (SEM). As a result, the formation of composite primary particles in which the conductive coating layer made of acetylene black was formed on the surfaces of the primary particles of positive electrode active material was observed, but no aggregate of the foregoing composite primary particles (i.e., secondary particle) was observed.

The non-aqueous electrolyte secondary battery of the present invention was fabricated in the same manner as in Example 1 except that the composite primary particles thus obtained was used in place of the composite primary particles of Example 1.

### Example 5

Primary and secondary particles of positive electrode active material were produced in the same manner as in Example 1. Subsequently, 80 parts by weight of the primary particles of positive electrode active material, 20 parts by weight of the secondary particles of positive electrode active material, and 3 parts by weight of acetylene black were dry-mixed for 30 minutes in the circulation-type mechanofusion system under the same conditions with those in Example 1, whereby a positive electrode active material being a mixture containing composite primary particles and composite secondary particles in a ratio of 80:20 (weight ratio) was produced.

The non-aqueous electrolyte secondary battery of the present invention was fabricated in the same manner as in Example 1 except that the positive electrode active material thus obtained was used in place of the composite primary particles of Example 1.

### Comparative Example 1

Secondary particles of positive electrode active material were produced in the same manner as in Example 1. Subsequently, 100 parts by weight of the secondary particles of positive electrode active material and 3 parts by weight of acetylene black were dry-mixed for 30 minutes in the circulation-type mechanofusion system under the same conditions with those in Example 1, whereby composite secondary particles were produced.

A non-aqueous electrolyte secondary battery was fabricated in the same manner as in Example 1 except that the composite primary particles thus obtained was used in place of the composite primary particles of Example 1.

### Comparative Example 2

Primary particles of positive electrode active material were produced in the same manner as in Example 1. The primary particles were not coated with acetylene black in the circulation-type mechanofusion system and were used as they were for the preparation of a positive electrode material mixture slurry. Specifically, 3 kg of the primary particles, 1000 g of polyvinylidene fluoride solution (KF1320), 150 g of acetylene black (conductive agent), and an appropriate amount of NMP were kneaded together in a planetary mixer, whereby a positive electrode material mixture slurry was prepared. Here, the acetylene black was used in a ratio of 5 parts by weight per 100 parts by weight of the primary particles of positive electrode active material.

A non-aqueous electrolyte secondary battery was fabricated in the same manner as in Example 1 except that the positive electrode material mixture slurry thus obtained was used in place of the positive electrode material mixture slurry of Example 1.

### Comparative Example 3

A non-aqueous electrolyte secondary battery was fabricated in the same manner as in Example 5 except that the ratio of the amount of the primary particles of positive electrode active material used to the amount of the secondary particles of positive active electrode material used were changed from 80:20 parts by weight to 70:30 parts by weight.

The non-aqueous electrolyte secondary batteries obtained in Examples 1 to 5 and Comparative Examples 1 to 3 were evaluated as described below.

(Capacity)

With respect to the batteries of Examples 1 to 5 and Comparative Examples 1 to 3, charge and discharge were performed in an environment of 25° C. at a constant current of 240 mA under the conditions of an end-of-charge voltage of 4.2 V and an end-of-discharge voltage of 2.5 V, and the battery capacities were measured. The result found that the initial battery capacities of these batteries were about 1200 mAh.

(Output Characteristics)

With respect to the batteries of Examples 1 to 5 and

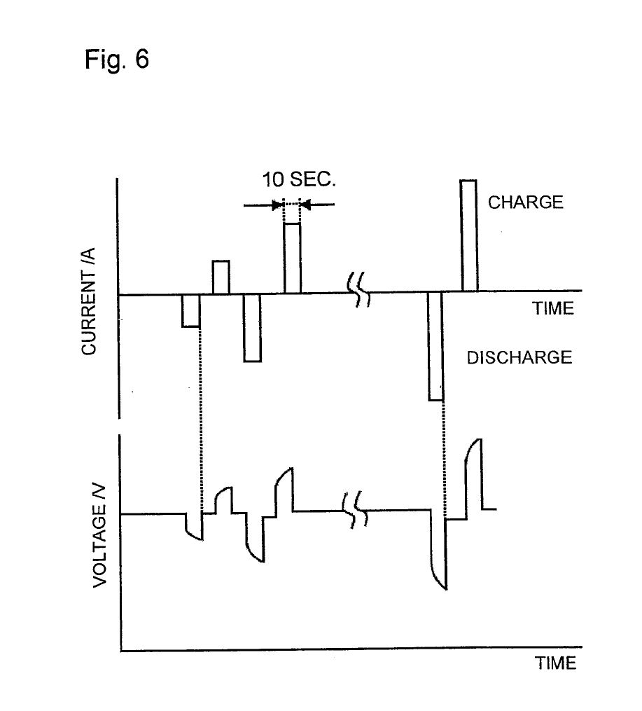

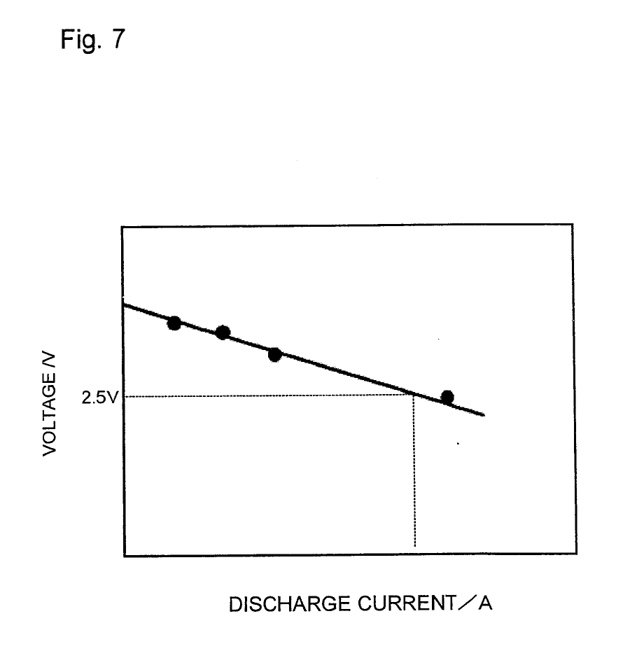

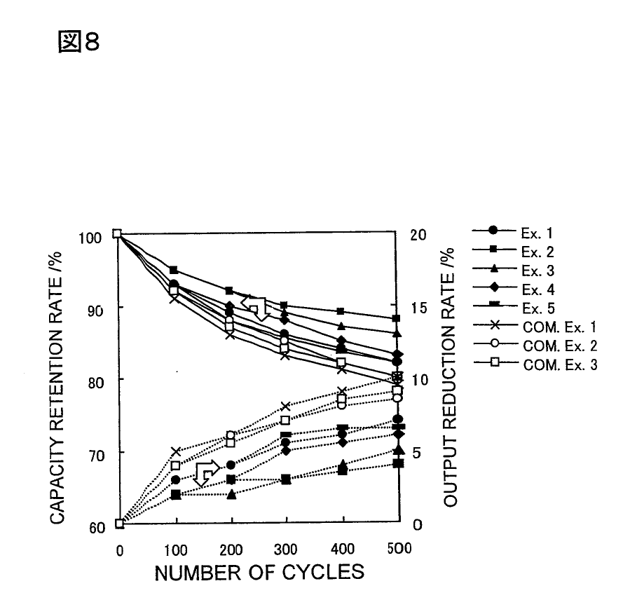

Comparative Examples 1 to 3, charge was performed at a constant current of 240 mAh in an environment of 25° C. to a 60% depth of charge, and the batteries were allowed to stand for 1 hour in an environment of 25° C. Then, in the pattern shown in FIG. 6, pulse charge and pulse discharge at a constant current were performed alternately (for 10 seconds each) with a 1-minute interval therebetween. FIG. 6 is a graph showing a pattern of pulse charge and pulse discharge at a constant current. In Examples herein, as shown in FIG. 6, the current value was increased stepwise within a range from 1 to 50 A, and the battery voltage 10 seconds after the application of each pulse was measured. From this test, the relationship between a current value when a pulse of discharge was applied and a battery voltage 10 seconds after the application of the pulse was determined. The results are shown in FIG. 7. FIG. 7 is a graph showing the relationship between a current and a voltage at the time of discharge (current-voltage characteristics graph). From FIG. 7, the current value corresponding to when the battery voltage was about 2.5 V was calculated, and from the product of the voltage value and the current value thus calculated, an output power was calculated. The results are shown in Table 1.

(Cycle Characteristics)

With respect to the batteries of Examples 1 to 5 and Comparative Examples 1 to 3, after the battery capacity and output characteristics in the initial stage were determined, a charge/discharge cycle was repeated in which, in an environment of 40° C., charge was performed at a constant current of 2.4 A until the voltage reached 4.2 V and discharge was performed at a constant current of 2.4 A until the voltage reached 2.5 V. For comparison with the discharge capacity and output characteristics in the initial stage, the discharge capacity and output characteristics at every 100 cycles were measured, and the capacity retention rate and the output reduction rate were plotted on the graph as the cycle characteristics. FIG. 8 is a graph showing the cycle characteristics of batteries of Examples 1 to 5 and Comparative Examples 1 to 3.

TABLE 1

| Non-aqueous electrolyte | Output power |
|---|---|
| secondary battery | (W) |
| Example 1 | 97 |
| Example 2 | 95 |
| Example 3 | 100 |
| Example 4 | 98 |
| Example 5 | 95 |
| Comparative Example 1 | 75 |
| Comparative Example 2 | 92 |
| Comparative Example 3 | 93 |

Table 1 shows the following. The output powers of the batteries of Examples 1 to 5 are larger than those of the batteries of Comparative Examples 1 to 3. From the comparison with the battery of Comparative Example 1, it is presumed that due to the pulverization into the primary particles of positive electrode active material, the positive electrode active material had an increased surface area, reducing the charge-transfer reaction resistance at the entire positive electrode. From the comparison with the battery of Comparative Example 2, it is presumed that due to the formation of the conductive coating layer on the surfaces of positive electrode active material particles, a conductive network was formed among the individual positive electrode active material particle, allowing the charge-transfer reaction to proceed favorably on the surfaces of the positive electrode active material particles.

From the comparison between the battery of Example 3 and the battery of Example 4, it is clear that, provided that the amounts of conductive agent used are the same, the output power is further improved when the conductive coating layer is formed and the conductive agent is allowed to be present in the positive electrode active material layer separately from the conductive coating layer than when the conductive coating layer only is merely formed on the surfaces of the primary particles of positive electrode active material. This is presumably because the presence of the conductive agent in the positive electrode active material layer separately from the conductive coating layer made it possible to maintain the electron conductivity in the positive electrode active material layer despite the changes in volume of the positive electrode associated with charge and discharge, resulted in further improvement in the output power.

From FIG. 8, with regard to the batteries of Examples 1 to 5, it is clear that, compared with the batteries of Comparative Examples 1 to 3, the capacity retention rate associated with charge/discharge cycling (repeated charge and discharge) is improved in the order of the battery of Example 5, the batteries of Examples 1 and 4, the battery of Example 3, and the battery of Example 2.

Here, the deterioration in the capacity and output associated with charge/discharge cycling is attributable to, for example, the following two factors. The first factor is that the secondary particles being the positive electrode active material were made finer by the stress of expansion and contraction of the positive electrode active material during charge and discharge, causing the primary particles present inside the secondary particles to be isolated from the conductive network in the positive electrode active material layer. The second factor is that the non-aqueous electrolyte solution decomposed and formed a coating layer on the surface of the active material, causing the reaction resistance to increase.

As for the deterioration factor in the batteries of comparative examples, in the battery of Comparative Example 1, the first factor was presumably predominant, since the positive electrode active material in the form of secondary particles was used. In the battery of Comparative Example 2, the second factor was presumably predominant, since the positive electrode active material in the form of primary particles without the conductive coating layer formed on the surfaces thereof was used, and the surface area of the positive electrode active material was merely increased by the pulverization into primary particles. In the battery of Comparative Example 3, the deterioration was presumably caused by the first factor, since the ratio of the primary particles of positive electrode active material to the secondary particles of positive electrode active material was 70:30 parts by weight, and the amount of the positive electrode active material in the form of secondary particles was large.

In contrast, in the batteries of Examples 1 and 4, the positive electrode active material in the form of primary particles was used, and in addition, the conductive coating layer was formed on the surfaces of the primary particles. That is, presumably, not only the first factor was eliminated by the use of the positive electrode active material in the form of primary particles, and but also the second factor was slightly eliminated by the formation of the conductive coating layer that suppressed the decomposition of the non-aqueous electrolyte solution on the surface of the positive electrode active material. Further, in the battery of Example 2, the alumina (metal oxide) layer was first formed on the surfaces of the primary particles of the positive electrode active material, and then the conductive coating layer was formed thereon. The formation of the alumina layer further suppressed the decomposition of the non-aqueous electrolyte solution on the surface of the positive electrode active material layer, and presumably for this reason, the second factor was remarkably eliminated.

In the battery of Example 3, the first and second factors were eliminated, and in addition, the inclusion of the conductive agent in the positive electrode active material layer separately from the conductive coating layer made it possible to maintain the electron conductivity in the positive electrode active material layer despite the changes in volume of the positive electrode associated with charge and discharge. Presumably for this reason, the life characteristics were further improved. Further, the battery of Example 5, which included the secondary particles of positive electrode active material in the ratio of 20% by weight of the total amount of the positive electrode active material, exhibited the cycle characteristics almost equivalent to the battery of Example 1, which included the positive electrode active material composed of primary particles only. This is presumably because the deterioration due to the first factor was small.

Based on the foregoing results, it is understood that by using the positive electrode for a non-aqueous electrolyte secondary battery of the present invention, it is possible to provide a non-aqueous electrolyte secondary battery having good output characteristics and good cycle characteristics.

### INDUSTRIAL APPLICABILITY

The non-aqueous electrolyte secondary battery of the present invention can be used for applications similar to those of conventional non-aqueous electrolyte secondary batteries, and, because of its good output characteristics and good cycle characteristics, is advantageously applicable as a power source for electric vehicles for which high output power and long life are required.

1. A positive electrode for a non-aqueous electrolyte secondary battery comprising: an active material layer; and a current collector carrying the active material layer formed on at least one surface thereof, wherein the active material layer contains an active material comprising a lithium composite metal oxide, 80% by weight or more of a total amount of the lithium composite metal oxide being in the form of primary particles of the lithium composite metal oxide, and the primary particles of the lithium composite metal oxide have a conductive coating layer formed on the surface thereof.

2. The positive electrode for a non-aqueous electrolyte secondary battery in accordance with claim 1, wherein the primary particles of the lithium composite metal oxide have a metal oxide layer containing a metal oxide different from the lithium composite metal oxide formed on the surface thereof, and further have the conductive coating layer formed on the surface of the metal oxide layer, the metal oxide different from the lithium composite metal oxide comprising one or two or more metal oxides selected from the group consisting of alumina, zeolite, titanium oxide, zirconium oxide, magnesium oxide, zinc oxide, and silicon dioxide.

3. The positive electrode for a non-aqueous electrolyte secondary battery in accordance with claim 1, wherein the conductive coating layer is formed on the surface of the primary particles of the lithium composite metal oxide by dry mixing of the primary particles of the active material and a conductive agent.

4. The positive electrode for a non-aqueous electrolyte secondary battery in accordance with claim 3, wherein the dry mixing is performed by a mechanochemical method.

5. The positive electrode for a non-aqueous electrolyte secondary battery in accordance with claim 1, wherein the active material layer contains the lithium composite metal oxide, 80% by weight or more of a total amount of the lithium composite metal oxide being in the form of primary particles of the lithium composite metal oxide, the primary particles of the lithium composite metal oxide have a conductive coating layer formed on the surface thereof, and the active material layer further contains a conducive agent.

6. A non-aqueous electrolyte secondary battery comprising: an electrode assembly including the positive electrode for a non-aqueous electrolyte secondary battery in accordance with claim 1, a negative electrode including an active material capable of absorbing and desorbing lithium ions, and a separator; and a non-aqueous electrolyte.
